(19) United States
(12) Patent Application Publication
(10) Pub. No.: US 2025/0210816 A1
(43) Pub. Date: Jun. 26, 2025

(54) A BATTERY PACK AND A METHOD OF ASSEMBLING THE BATTERY PACK

(71) Applicant: TVS MOTOR COMPANY LIMITED, Chennai (IN)

(72) Inventors: P Kambi Reddy, Chennai (IN); R Shyam Kousik, Chennai (IN); Sarvani Kuchibhotla, Chennai (IN); Ayan Shree, Chennai (IN); Kandregula Srinivasa Rao, Chennai (IN); N Pramila Rao, Chennai (IN)

(73) Assignee: TVS MOTOR COMPANY LIMITED, Chennai (IN)

(21) Appl. No.: 18/850,675

(22) PCT Filed: Mar. 6, 2023
(86) PCT No.: PCT/IN2023/050203

§ 371 Date: Sep. 25, 2024

(30) Foreign Application Priority Data
Mar. 26, 2022 (IN) 202241017517

(51) Int. Cl. H01M 50/503; H01M 50/204; H01M 50/244; H01M 50/35; H01M 50/507; H01M 50/516; H01M 50/548

(52) U.S. Cl. CPC H01M 50/503; H01M 50/204; H01M 50/244; H01M 50/35; H01M 50/507; H01M 50/516; H01M 50/548

(57) ABSTRACT

A battery pack includes: a plurality of battery cells, each battery cell of the plurality of battery cells having a positive terminal and a negative terminal; one or more top holders and one or more bottom holders adapted to receive end portions of the plurality of battery cells; and one or more top plates arranged on the one or more top holders and one or more bottom plates arranged on the one or more bottom holders, each of the one or more top plates and the one or more bottom plates having a plurality of interconnectors and each of the plurality of interconnectors having a hole and a connecting structure extending from the hole to enable contact with the positive terminal of the battery cell.

### FIELD OF THE INVENTION

The present invention relates to a battery pack and a method of assembling the battery pack. More particularly, the present invention relates to interconnectors in the battery pack.

### BACKGROUND OF THE INVENTION

A battery pack is a set of plurality of battery cells connected in series, parallel or a combination of series and parallel to deliver desired voltage, capacity, or power density. The battery pack comprises interconnectors which provide electrical conductivity between the plurality of battery cells.

The battery cells, especially non-insulated battery cells, and other components in the battery pack generate heat during operation of the battery pack, both during charging process to store energy and during discharging process when energy is consumed. Also, when the battery cells fail in the battery pack due to short circuits etc., hot gases are released which generates heat. The heat generated in the battery pack during charging/discharging process and/or release of hot gases due to failure of battery cells negatively impact the integrity of the battery cells in the battery pack and may cause substantial damage to the functional cells of the battery pack. This, in turn, will negatively affect the life of the battery pack which is undesirable.

Further, it is difficult and expensive to interconnect the plurality of battery cells in the battery pack using welding. In order to minimize possibility of a weld failure, complicated weld patterns are required to be created. Welding defects result in low capacity, short circuits and possibility of heating in poor weld joints. The greater the number of cells in the battery pack, the greater is the risk of failure of the battery pack. This translates into higher production costs and operational costs of battery packs which is undesirable.

Further, when the plurality of non-insulated battery cells are arranged in cell holders, the cell holders allow negative terminals of the battery cells to be insulated which creates a gap between the positive terminals and the interconnectors, thereby making the welding of interconnectors to positive terminals of the battery cells difficult.

In view of the foregoing, there is a need-felt to overcome the above-mentioned disadvantages.

### SUMMARY OF THE INVENTION

In one aspect, a battery pack comprising a plurality of battery cells, one or more top holders, one or more bottom holders, one or more top plates and one or more bottom plates is disclosed. Each of the plurality of battery cells comprises a positive terminal and a negative terminal. The one or more top holders and the one or more bottom holders are adapted to receive the end portions of the plurality of battery cells. The one or more top plates are arranged on the one or more top holders. The one or more bottom plates are arranged on the one or more bottom holders. Each of the one or more top plates and the one or more bottom plates comprises a plurality of interconnectors. Each of the plurality of interconnectors comprises a hole and a connecting structure extending from the hole to enable contact with the positive terminal of the battery cell.

In an embodiment, the connecting structure comprises a first member extending in a direction towards the battery cell and a second member extending from the first member in a direction parallel to a longitudinal axis of the battery pack.

In an embodiment, the connecting structure comprises a first member extending in a direction towards the battery cell and a second member extending from the first member in a direction parallel to a lateral axis of the battery pack.

In an embodiment, the plurality of battery cells are non-insulated cells.

In an embodiment, a space is provided between the second member of each of the plurality of interconnectors and each of the one or more top plates/bottom plates for expelling gases and dissipating heat from the battery pack.

In an embodiment, each of the one or more top plates and the one or more bottom plates comprises flat portions between the plurality of interconnectors. The flat portions are in contact with the negative terminals of the plurality of battery cells.

In an embodiment, the second member of the connecting structure is welded to the positive terminal of the battery cell.

In another aspect of the invention, a method of assembling a battery pack comprising a plurality of battery cells, one or more top holders, one or more bottom holders, one or more top plates and one or more bottom plates is disclosed. The method comprises a step of arranging end portions of a plurality of battery cells in one or more top holders and one or more bottom holders. Each of the plurality of battery cells comprises a positive terminal and a negative terminal. The method further comprises the step of arranging one or more top plates on the one or more top holders and arranging one or more bottom plates on the one or more bottom holders. Each of the one or more top plates and the one or more bottom plates comprises a plurality of interconnectors. Each of the plurality of interconnectors comprises a hole and a connecting structure extending from the hole to enable contact with the positive terminal of the battery cell. The method further comprises the step of connecting the connecting structures of the plurality of interconnectors to the positive terminals of the plurality of battery cells. In one non-limiting example, the plurality of interconnectors are connected to the positive terminals of the plurality of battery cells by welding.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 is a perspective view of the battery pack, in accordance with an embodiment of the present invention.

FIG. 2 is an exploded view of the battery pack, in accordance with an embodiment of the present invention.

FIG. 3 is an exploded view of the battery pack, in accordance with an embodiment of the present invention.

FIG. 4 illustrates a perspective view of the top plate and bottom plate comprising a plurality of interconnectors, in accordance with an embodiment of the present invention.

FIG. 5 is a sectional view of the interconnector illustrating the connecting structure, in accordance with an embodiment of the present invention.

FIG. 6 is a sectional view of the battery pack illustrating connection of the battery cells with interconnectors, in accordance with an embodiment of the present invention.

FIG. 7 illustrates a flow chart for a method of assembling the battery pack, in accordance with an embodiment of the present invention.

### DETAILED DESCRIPTION OF THE INVENTION

Various features and embodiments of the present invention here will be discernible from the following further description thereof, set out hereunder.

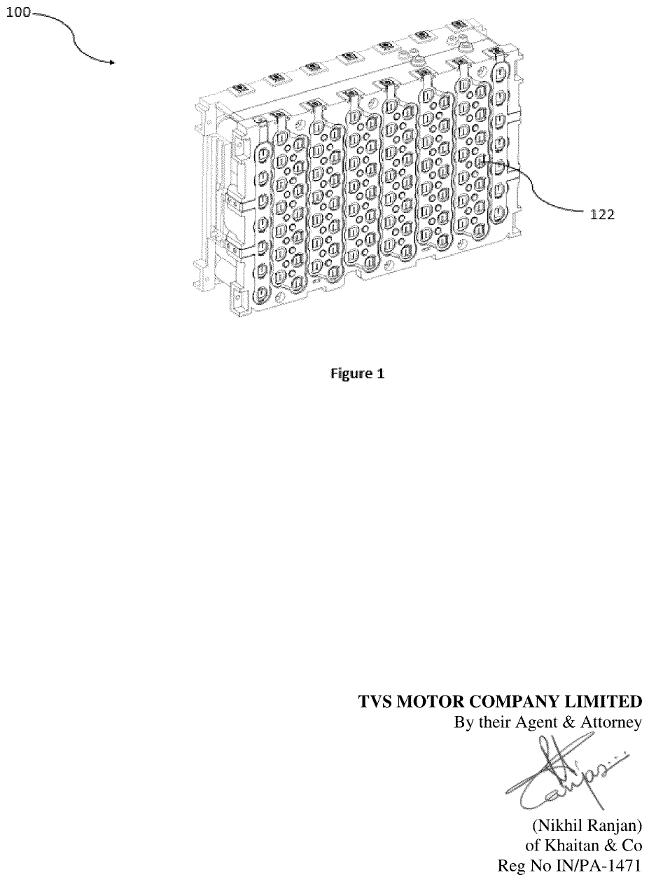

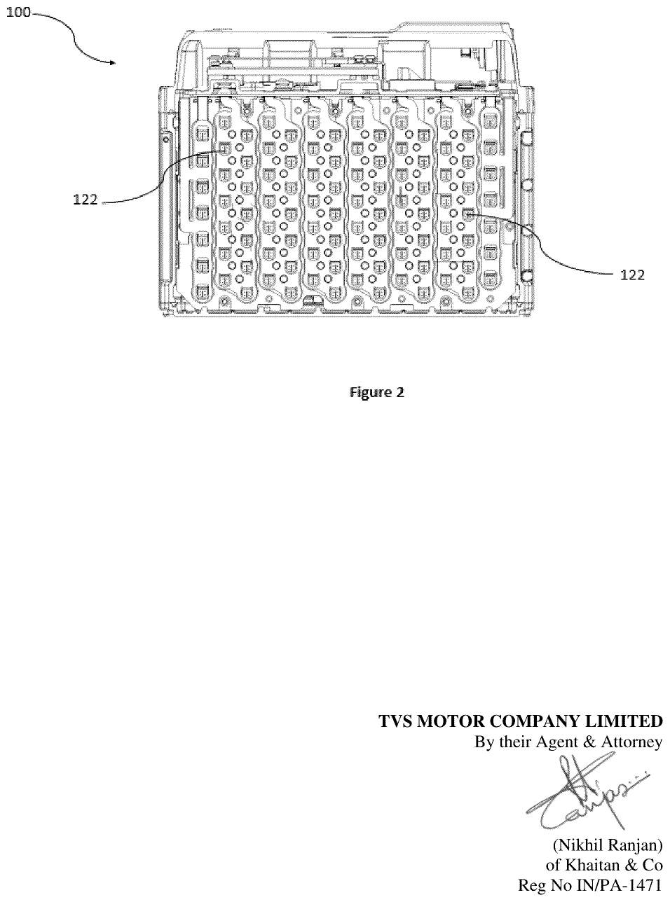

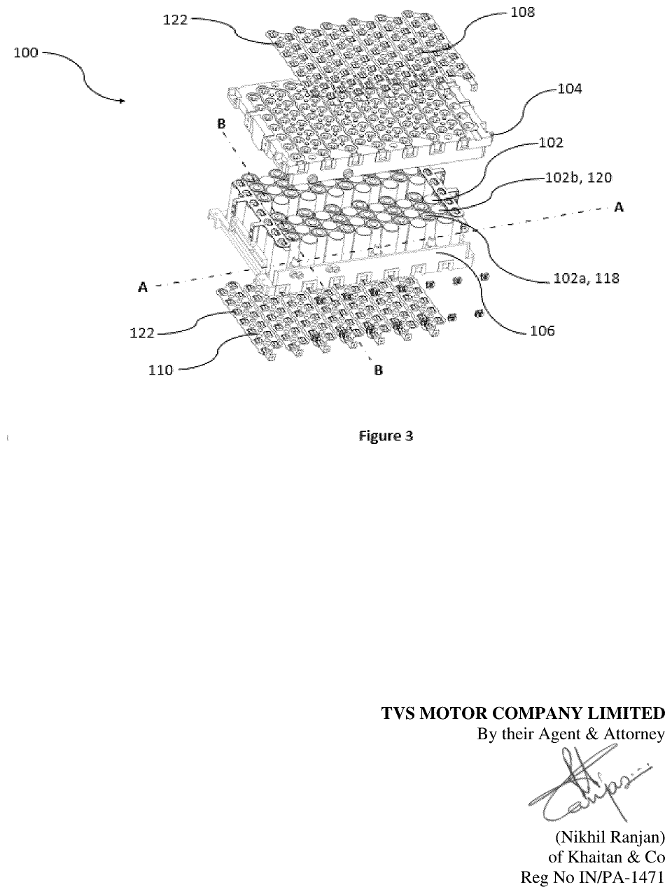

FIG. 1 is a perspective view of a battery pack 100, in accordance with an embodiment of the present invention. FIG. 2 is a sectional view of the battery pack 100, in accordance with an embodiment of the present invention. FIG. 3 is an exploded view of the battery pack 100, in accordance with an embodiment of the present invention.

As shown, the battery pack 100 comprises a plurality of battery cells 102, one or more top holders 104, one or more bottom holders 106, one or more top plates 108 and one or more bottom plates 110. The longitudinal axis A-A and lateral axis B-B of the battery pack 100 have also been shown in FIG. 3.

The plurality of battery cells 102 may be conventional battery cells which converts chemical energy of substances stored in the battery cells into electrical energy. Each of the plurality of battery cells 102 comprises a first end 102a and a second end 102b. Each of the plurality of battery cells 102 comprises a positive terminal and a negative terminal. The positive terminal preferentially protrudes from the first end 102a the battery cell 102. The negative terminal preferentially begins on the second end 102b of the battery cell 102 and continues on an outer surface of the battery cell 102 and wraps at least to a portion of first end 102a of the batter cell 102. End portions of each of the plurality of battery cells 102 are portions proximate to the first end 102a and the second end 102b of the battery cell 102. In other words, a first end portion is an area proximate the first end 102a of the battery cell 102 and a second end portion is an area proximate the second end 102b of the battery cell 102. The battery cells 102 may be insulated or non-insulated.

The one or more top holders 104 and the one or more bottom holders 106 are adapted to receive end portions of the plurality of battery cells 102. Each of the one or more top holders 104 and one or more bottom holders 106 may be a box shaped enclosure comprising means to accommodate the battery cells in an upright manner. In one non limiting example, each of the one or more top holders and one or more bottom holders comprises a base and four side walls supported on the base. The side walls may be attached to the base through any suitable joining means such as fasteners. The side walls may also be integrally formed with the base. The base may comprise slots or any other such means to accurately position the end portions of the plurality of battery cells.

As shown in FIG. 3, the plurality of battery cells 102 comprises a first set of battery cells 118 and a second set of battery cells 120. The first end portion of each of the first set of battery cells 118 is received in the one or more top holders 104 and the second end portion of each of the first set of battery cells 118 is received in the one or more bottom holders 106. The first end portion of each of the second set of battery cells 120 is received in the one or more bottom holders 106 and the second end portion of each of the second set of battery cells 120 is received in the one or more top holders 104.

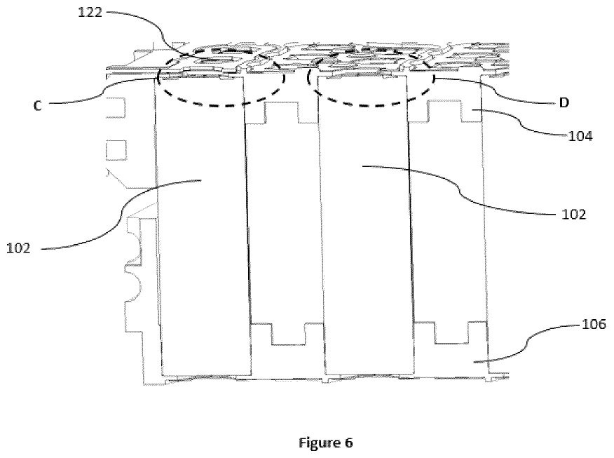

The one or more top plates 108 are arranged on the one or more top holders 104 and the one or more bottom plates 110 are arranged on the one or more bottom holders 106. Each of the one or more top plates 108 and the one or more bottom plates 110 comprises a plurality of interconnectors 122. Each interconnector 122 has a hole 124 and a connecting structure 126 extending from the hole 124 to enable contact with the positive terminal of the battery cell 102 as shown in FIG. 6.

In an embodiment, the connecting structure 126 comprises a first member 126a extending in a direction towards the battery cell 102 and a second member 126b extending from the first member 126a in a direction parallel to a longitudinal axis A-A of the battery pack 100. In one non-limiting example, the connecting structure 126 is a L-shaped member wherein the first member 126a is a straight member. In another non-limiting example, the first member is a slant member.

In an embodiment, the connecting structure 126 comprises a first member 126a extending in a direction towards the battery cell 102 and a second member 126b extending from the first member 126a in a direction parallel to a lateral axis B-B of the battery pack 100. In one non-limiting example, the connecting structure 126 is a L-shaped member wherein the first member 126a is a straight member. In another non-limiting example, the first member is a slant member.

In an embodiment, the plurality of battery cells 102 are non-insulated cells.

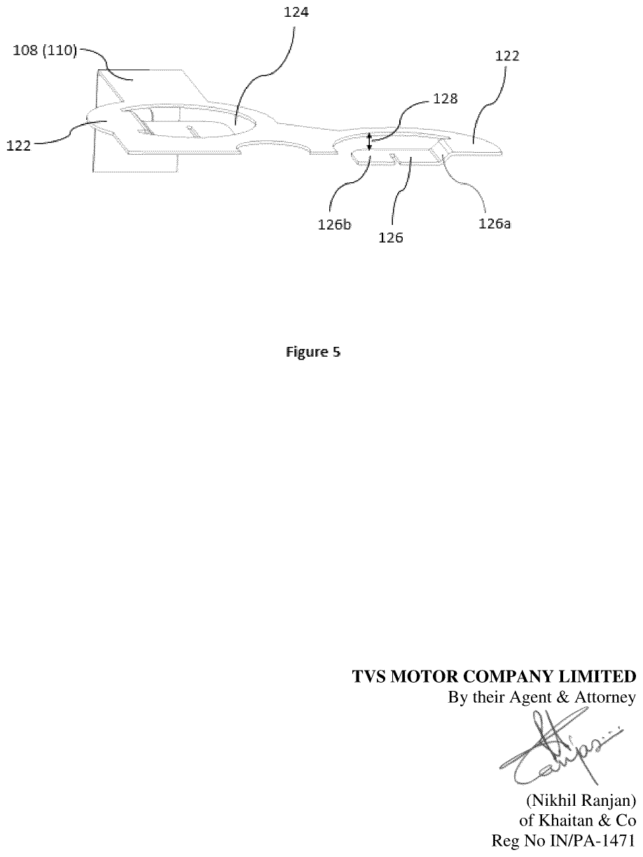

In an embodiment, a space 128 (shown in FIG. 5) is provided between the second member 126b of each of the plurality of interconnectors and each of the one or more top plates/bottom plates 108, 110 for expelling gases and dissipating heat from the battery pack 100.

In an embodiment, each of the one or more top plates 108 and the one or more bottom plates 110 comprises flat portions 130 between the plurality of interconnectors 122. The flat portions 130 are in contact with the negative terminals of the plurality of battery cells 102.

In an embodiment, the second member 126b of the connecting structure 126 is welded to the positive terminal of the battery cell 102.

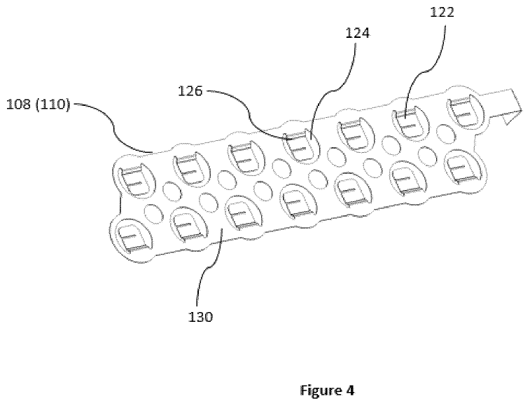

FIG. 4 illustrates a perspective view of the top plate and bottom plate 108, 110 comprising a plurality of interconnectors 122, in accordance with an embodiment of the present invention. FIG. 5 is a sectional view of the interconnector 122 illustrating the connecting structure 126, in accordance with an embodiment of the present invention.

As shown, the top plate and bottom plate 108, 110 of the battery pack 100 comprises plurality of interconnectors 122. Each of the plurality of interconnectors 122 has the hole 124 and the connecting structure 126 extending from the hole 124 to enable contact with the positive terminal of the battery cell 102.

Also, as shown, the space 128 is provided between the second member 126b of each of the plurality of interconnectors 122 and each of the one or more top plates/bottom plates 108, 110 for expelling gases and dissipating heat from the battery pack 100. Each of the one or more top plates 108 and the one or more bottom plates 110 comprises flat portions 130 between the plurality of interconnectors 122. The flat portions 130 are in contact with the negative terminals of the plurality of battery cells 102.

In an embodiment, the connecting structure 126 comprises a first member 126a extending in a direction towards the battery cell 102 and a second member 126b extending from the first member 126a in a direction parallel to a longitudinal axis A-A of the battery pack 100. In one non-limiting example, the connecting structure 126 is a L-shaped member wherein the first member 126a is a straight member. In another non-limiting example, the first member is a slant member.

In an embodiment, the connecting structure 126 comprises a first member 126a extending in a direction towards the battery cell 102 and a second member 126b extending from the first member 126a in a direction parallel to a lateral axis B-B of the battery pack 100. In one non-limiting example, the connecting structure 126 is a L-shaped member wherein the first member 126a is a straight member. In another non-limiting example, the first member is a slant member.

FIG. 6 is a sectional view of the battery pack illustrating connection of the battery cells 102 with interconnectors 122, in accordance with an embodiment of the present invention.

The dashed circle C and D indicates the connection of the interconnector 122 with the positive terminal of the battery cell 102. In one non-limiting example, the second member 126b of the connecting structure 126 is welded to the positive terminal of the battery cell 102.

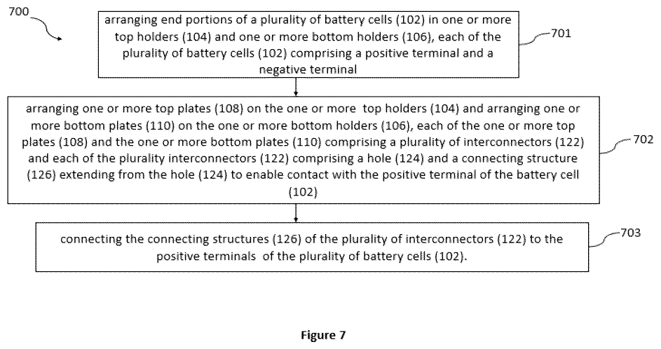

FIG. 7 illustrates a flow chart for a method 700 of assembling the battery pack 100, in accordance with an embodiment of the present invention.

At step 701, the method comprises arranging end portions of a plurality of battery cells 102 in one or more top holders 104 and one or more bottom holders 106. Each battery cell 102 of the plurality of battery cells 102 comprises a positive terminal and a negative terminal.

At step 702, the method comprises arranging one or more top plates 108 on the one or more top holders 104 and arranging one or more bottom plates 110 on the one or more bottom holders 106. Each of the one or more top plates 108 and the one or more bottom plates 110 comprises a plurality of interconnectors 122. Each of the plurality of interconnectors 122 comprises a hole 124 and a connecting structure 126. The connecting structure extends from the hole 124 to enable contact with the positive terminal of the battery cell 102.

At step 703, the method comprises welding the connecting structures 126 of the plurality of interconnectors 122 to the positive terminals of the plurality of battery cells 102. In one non-limiting example, the plurality of interconnectors are connected to the positive terminals of the plurality of battery cells by welding.

The claimed features/steps of the present invention as discussed above are not routine, conventional, or well understood in the art, as the claimed steps enable the following solutions to the existing problems in conventional technologies. Specifically, the technical problem of dissipating heat from the battery pack 100 during charging/discharging of battery packs 100, difficulty in welding of battery cells 102 to interconnectors 122 owing to issues such as cell float, short circuiting etc., improper insulation in battery packs 100 having non-insulated battery cells 102 are solved by present invention.

The present invention provides better access to battery cells 102 for welding. The second member 126b of the connecting structure 126 allows for better accessibility to the positive terminal of the battery cell 102 while welding. In cases, where a gap occurs between the top plate 108 and the positive terminal of the battery cell 102, the second member 126 of the connecting structure 126 can be pressed to reach the positive terminal of the battery cell 102 for better welding. In other words, the present invention provides scope for cell float to be adjusted with second member 126b of the interconnector 122 while welding. The weld pull-off strength is also increased with the present invention.

Further, the space between the top plate/bottom plate 108, 110 and the second member 126b allows for release of hot gases from the battery pack 100 generated during failure of battery cells or dissipation of heat during charging/discharging of the battery pack. This is particularly true for battery packs 100 with non-insulated battery cells 102.

Further, the second member 126b of the interconnector also allows for connection between the battery cells 102 and the interconnectors 122 without risk of short circuiting. This is particularly true for battery packs 100 with non-insulated battery cells 102.

Further, in battery packs 100 having non-insulated battery cells 102, the top holder 104 and bottom holder 106 allows the negative terminals of the battery cells 102 to be insulated which creates a gap between the positive terminal of the battery cells 102 and the interconnectors 122. The second member 126b of the connecting structure 126 of the interconnector 122 in the present invention allows to overcome this problem and give better connection between the positive terminal of the battery cells 102 and the interconnectors 122.

While the present invention has been described with respect to certain embodiments, it will be apparent to those skilled in the art that various changes and modification may be made without departing from the scope of the invention as defined in the following claims.

### LIST OF REFERENCE NUMERALS

100—battery pack
102—battery cells
102a—first end
102b—second end
104—top holder
106—bottom holder
108—top plates
110—bottom plates
118—first set of battery calls
120—second set of battery cells
122—interconnectors
124—hole
126—connecting structure
126a—first member
126b—second member
128—space
130—flat portions
A-A—longitudinal axis

1.-9. (canceled)

10. A battery pack comprising:
a plurality of battery cells, each battery cell of the plurality of battery cells having a positive terminal and a negative terminal;
one or more top holders and one or more bottom holders adapted to receive end portions of the plurality of battery cells; and
one or more top plates arranged on the one or more top holders and one or more bottom plates arranged on the one or more bottom holders,
each of the one or more top plates and the one or more bottom plates having a plurality of interconnectors and
each of the plurality of interconnectors having a hole and a connecting structure extending from the hole to enable contact with the positive terminal of the battery cell.

11. The battery pack as claimed in claim 10, wherein
the connecting structure comprises
a first member extending in a direction towards the battery cell and
a second member extending from the first member in a direction parallel to a longitudinal axis of the battery pack.

12. The battery pack as claimed in claim 10, wherein
the connecting structure comprises
a first member extending in a direction towards the battery cell and
a second member extending from the first member in a direction parallel to a lateral axis of the battery pack.

13. The battery pack as claimed in claim 10, wherein
the plurality of battery cells are non-insulated cells.

14. The battery pack as claimed in claim 11, wherein
a space is provided between the second member of each of the plurality of interconnectors and each of the one or more top plates or the one or more bottom plates for expelling gases and dissipating heat from the battery pack.

15. The battery pack as claimed in claim 10, wherein
each of the one or more top plates and the one or more bottom plates comprises flat portions between the plurality of interconnectors,
the flat portions being in contact with the negative terminals of the plurality of battery cells.

16. The battery pack as claimed in claim 11, wherein
the second member of the connecting structure is welded to the positive terminal of the battery cell.

17. A method of assembling a battery pack, the method comprising:
arranging end portions of a plurality of battery cells in one or more top holders and one or more bottom holders, each of the plurality of battery cells having a positive terminal and a negative terminal;
arranging one or more top plates on the one or more top holders and arranging one or more bottom plates on the one or more bottom holders,
each of the one or more top plates and the one or more bottom plates having a plurality of interconnectors and
each of the plurality interconnectors having a hole and a connecting structure extending from the hole to enable contact with the positive terminal of the battery cell; and
connecting the connecting structures of the plurality of interconnectors to the positive terminals of the plurality of battery cells.

18. The method of assembling the battery pack as claimed in claim 17, wherein
the plurality of interconnectors are connected to the positive terminals of the plurality of battery cells by welding.
